(19) United States
(12) Patent Application Publication
(10) Pub. No.: US 2024/0407393 A1
(43) Pub. Date: Dec. 12, 2024

(54) FOOD FLAKES WITH HIGH PROTEIN CONTENT

(71) Applicant: Post Consumer Brands, LLC, Lakeville, MN (US)

(72) Inventor: Paul-Armand Claon, Lakeville, MN (US)

(21) Appl. No.: 18/747,087

(22) Filed: Jun. 18, 2024

Related U.S. Application Data
(63) Continuation-in-part of application No. 17/738,732, filed on May 6, 2022, now Pat. No. 12,011,023.
(60) Provisional application No. 63/227,797, filed on Jul. 30, 2021.

(51) Int. Cl. A23J 3/26; A23J 3/18; A23L 11/00; A23P 30/30

(52) U.S. Cl. CPC A23J 3/26; A23J 3/18; A23L 11/05; A23P 30/30

(57) ABSTRACT

Embodiments herein relate to high protein, ready-to-eat food flakes. In an embodiment, a method of making high protein flakes is included. The method can include forming an ingredient mixture including wheat gluten, wheat protein isolate, pea protein concentrate, wherein the wheat protein isolate and the pea protein concentrate are in a ratio of 2:1 to 1:2 by weight, and at least one of lactic acid, citric acid, and malic acid. The method can further include extruding the ingredient mixture to produce extruded pellets, flaking the extruded pellets to produce wet flakes, and puffing and toasting the wet flakes to produce finished flakes, wherein the finished flakes have a protein content of at least 50 wt. %. Other embodiments are also included herein.

This application is a continuation-in-part of U.S. patent application Ser. No. 17/738,732, filed on May 6, 2022, which claims the benefit of U.S. Provisional Application No. 63/227,797, filed Jul. 30, 2021, the content of which is herein incorporated by reference in its entirety.

### FIELD Embodiments herein relate to high protein flakes and methods of creating the same. More specifically, embodiments herein relate to high protein, ready-to-eat food flakes with a light texture.

### BACKGROUND

High protein diets have become popular. Eating protein helps a person feel full, which can lead to them eating fewer calories overall. High protein diets can also provide sustained energy and support muscle maintenance and growth. High protein diets typically include large quantities of protein and only a relatively small amount of carbohydrate. Food items with high protein content have become very popular with consumers even amongst those following other types of diets.

Breakfast cereals were first introduced in the 1800s and are extremely popular today as they provide both convenience, as ready-to-eat food products, along with pleasing flavors and textures. Many breakfast cereals contain substantial carbohydrate content.

### SUMMARY

Embodiments herein relate to high protein, ready-to-eat food flakes with a light texture. In a first aspect, a method of making high protein flakes is included. The method includes forming an ingredient mixture, the ingredient mixture can include wheat gluten, wheat protein isolate, pea protein concentrate, wherein the wheat protein isolate and the pea protein concentrate can be in a ratio of 2:1 to 1:2 by weight, and at least one of lactic acid, citric acid, and malic acid. The method further includes extruding the ingredient mixture to produce extruded pellets, flaking the extruded pellets to produce wet flakes, and puffing and toasting the wet flakes to produce finished flakes. The finished flakes have a protein content of at least 50 wt. %.

In a second aspect, in addition to one or more of the preceding or following aspects, or in the alternative to some aspects, the ingredient mixture includes lactic acid.

In a third aspect, in addition to one or more of the preceding or following aspects, or in the alternative to some aspects, the lactic acid can be included at an amount of 0.6 wt. % to 1.2 wt. % of the total of the wheat gluten, the wheat protein isolate, and the pea protein concentrate.

In a fourth aspect, in addition to one or more of the preceding or following aspects, or in the alternative to some aspects, the lactic acid can be included at an amount sufficient to lower the pH of the wet flakes to a pH of 6 or less.

In a fifth aspect, in addition to one or more of the preceding or following aspects, or in the alternative to some aspects, the wet flakes have a pH of 4 to 6.

In a sixth aspect, in addition to one or more of the preceding or following aspects, or in the alternative to some aspects, the method can further include adding a pregelatinized or precooked starch to the ingredient mixture.

In a seventh aspect, in addition to one or more of the preceding or following aspects, or in the alternative to some aspects, the pregelatinized or precooked starch can include at least one of a pregelatinized corn starch, a pregelatinized rice starch, a pregelatinized potato flour, a pregelatinized tapioca flour, and a precooked pulse flour.

In an eighth aspect, in addition to one or more of the preceding or following aspects, or in the alternative to some aspects, the finished flakes have a protein content of at least 60 wt. %.

In a ninth aspect, in addition to one or more of the preceding or following aspects, or in the alternative to some aspects, the finished flakes having a moisture content of 1 to 5 wt. %.

In a tenth aspect, in addition to one or more of the preceding or following aspects, or in the alternative to some aspects, the finished flakes having a moisture content of 2 to 3 wt. %.

In an eleventh aspect, in addition to one or more of the preceding or following aspects, or in the alternative to some aspects, the finished flakes having a bulk density of 50 to 120 g/L.

In a twelfth aspect, in addition to one or more of the preceding or following aspects, or in the alternative to some aspects, the ingredient mixture can further include: from 33 to 44 weight percent of the wheat gluten, from 17 to 37 weight percent of the wheat protein isolate, and from 15 to 35 weight percent of the pea protein concentrate, and wherein the preceding weight percentages can be with respect to a total weight of the wheat gluten, the wheat protein isolate, and the pea protein concentrate.

In a thirteenth aspect, in addition to one or more of the preceding or following aspects, or in the alternative to some aspects, the ingredient mixture can further include: from 36 to 41 weight percent of the wheat gluten, from 30 to 34 weight percent of the wheat protein isolate, and from 27 to 32 weight percent of the pea protein concentrate, and wherein the preceding weight percentages can be with respect to a total weight of the wheat gluten, the wheat protein isolate, and the pea protein concentrate.

In a fourteenth aspect, in addition to one or more of the preceding or following aspects, or in the alternative to some aspects, the method can further include adding glycerol monostearate to the ingredient mixture.

In a fifteenth aspect, in addition to one or more of the preceding or following aspects, or in the alternative to some aspects, the extruded pellets having a density of 475 to 700 g/L.

In a sixteenth aspect, in addition to one or more of the preceding or following aspects, or in the alternative to some aspects, the extruded pellets having a density of 450 to 650 g/L.

In a seventeenth aspect, in addition to one or more of the preceding or following aspects, or in the alternative to some aspects, the extruded pellets have a moisture content of 27 to 30 wt. percent. In an eighteenth aspect, in addition to one or more of the preceding or following aspects, or in the alternative to some aspects, the wet flakes having a thickness of 90 to 250 microns.

In a nineteenth aspect, in addition to one or more of the preceding or following aspects, or in the alternative to some aspects, the wet flakes having a moisture content of 26 to 31 wt. percent.

In a twentieth aspect, in addition to one or more of the preceding or following aspects, or in the alternative to some aspects, the wet flakes having a moisture content of 26 to 29 wt. percent.

In a twenty-first aspect, in addition to one or more of the preceding or following aspects, or in the alternative to some aspects, the extruded pellets can be at a temperature of 80 to 200 degrees Fahrenheit before flaking.

In a twenty-second aspect, in addition to one or more of the preceding or following aspects, or in the alternative to some aspects, the extruded pellets can be at a temperature of 100 to 150 degrees Fahrenheit before flaking.

In a twenty-third aspect, in addition to one or more of the preceding or following aspects, or in the alternative to some aspects, the operation of extruding can be performed with a screw speed of 200 to 400 RPM.

In a twenty-fourth aspect, in addition to one or more of the preceding or following aspects, or in the alternative to some aspects, the operation of extruding can be performed with a screw speed of 300 to 350 RPM.

In a twenty-fifth aspect, in addition to one or more of the preceding or following aspects, or in the alternative to some aspects, the operation of extruding can be performed with a barrel temperature of 35 to 40 degrees Celsius.

In a twenty-sixth aspect, in addition to one or more of the preceding or following aspects, or in the alternative to some aspects, wherein at least 90 percent by weight of the total protein content of the finished flakes can be plant protein.

In a twenty-seventh aspect, in addition to one or more of the preceding or following aspects, or in the alternative to some aspects, wherein at least 99 percent by weight of the total protein content of the finished flakes can be plant protein.

In a twenty-eighth aspect, in addition to one or more of the preceding or following aspects, or in the alternative to some aspects, wherein at least 100 percent by weight of the total protein content of the finished flakes can be plant protein.

In a twenty-ninth aspect, a high-protein flaked food product can be included having a plurality of high-protein flakes wherein the high-protein flakes can include wheat gluten, wheat protein isolate, pea protein concentrate, and at least one of lactic acid, citric acid, and malic acid. The high-protein flakes have an average protein content of at least 50% by weight and the wheat protein isolate and the pea protein concentrate can be in a ratio of 2:1 to 1:2 by weight.

In a thirtieth aspect, in addition to one or more of the preceding or following aspects, or in the alternative to some aspects, the high-protein flakes can include lactic acid.

In a thirty-first aspect, in addition to one or more of the preceding or following aspects, or in the alternative to some aspects, the flakes have a pH of 4 to 6.

In a thirty-second aspect, in addition to one or more of the preceding or following aspects, or in the alternative to some aspects, the high-protein flakes have an average protein content of at least 60% by weight.

In a thirty-third aspect, in addition to one or more of the preceding or following aspects, or in the alternative to some aspects, the plurality of high-protein flakes have, on average, a net area that can be at least 85% of an average convex area of the plurality of high-protein flakes.

In a thirty-fourth aspect, in addition to one or more of the preceding or following aspects, or in the alternative to some aspects, the plurality of high-protein flakes have, on average, a net area that can be at least 95% of the convex area of the plurality of high-protein flakes.

In a thirty-fifth aspect, in addition to one or more of the preceding or following aspects, or in the alternative to some aspects, the plurality of high-protein flakes have, on average, a net area that can be at least 99% of an average convex area of the plurality of high-protein flakes.

In a thirty-sixth aspect, in addition to one or more of the preceding or following aspects, or in the alternative to some aspects, wherein the wheat gluten can be from 26 to 34 wt. % of the high-protein flakes, wherein the wheat protein isolate can be from 21 to 30 wt. % of the high-protein flakes, and wherein the pea protein concentrate can be from 19 to 27 wt. % of the high-protein flakes.

In a thirty-seventh aspect, in addition to one or more of the preceding or following aspects, or in the alternative to some aspects, wherein the wheat gluten can be from 28 to 32 wt. % of the high-protein flakes, wherein the wheat protein isolate can be from 23 to 28 wt. % of the high-protein flakes, and wherein the pea protein concentrate can be from 21 to 25 wt. % of the high-protein flakes.

In a thirty-eighth aspect, in addition to one or more of the preceding or following aspects, or in the alternative to some aspects, the plurality of high-protein flakes lack pores greater than 1 mm in diameter.

In a thirty-ninth aspect, in addition to one or more of the preceding or following aspects, or in the alternative to some aspects, the plurality of high-protein flakes having a bulk density of 50 to 120 g/L.

In a fortieth aspect, in addition to one or more of the preceding or following aspects, or in the alternative to some aspects, the protein content can be at least 90 percent by weight plant protein.

In a forty-first aspect, in addition to one or more of the preceding or following aspects, or in the alternative to some aspects, the protein content can be at least 99 percent by weight plant protein.

In a forty-second aspect, in addition to one or more of the preceding or following aspects, or in the alternative to some aspects, the protein content can be 100 percent by weight plant protein.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a flowchart showing a method of making high protein flakes in accordance with various embodiments herein.

FIG. 2 is a schematic view of intermediate products and finished high protein flakes in accordance with various embodiments herein.

FIG. 3 is a graph showing texture analysis results of different flake formulations.

FIG. 4 is a graph showing texture analysis of flakes made from pellets having different moisture contents.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Ready-to-eat breakfast cereals are an extremely popular food, but typically have relatively high amounts of carbohydrates and low amounts of protein. As discussed above, high protein diets have become very popular. Further, even apart from high protein diets, food items with high protein content have become very popular with consumers. However, some food items high protein content may have off-flavors and textures that do not provide the sensory experiences that consumers are looking for.

Embodiments herein include high protein flaked food products, high protein flakes and methods of making the same. Embodiments herein particularly include high plant protein flakes (e.g., where the protein content is plant protein). High plant protein flakes can be challenging to make as they tend to become very dense and hard. However, high plant protein flakes herein can include high amounts of protein while still maintaining desirable sensory properties including a light texture and high levels of flake integrity. Flake integrity can be particularly important with ready-to-eat cereals so that the product does not fall apart during packaging, distribution, sales, storage, and/or handling before consumer end use. The term “high protein” in regard to flakes shall refer herein to flakes that have at least 30% by weight protein content. Remarkably, however, the high protein flakes herein can have an average protein content of at least 50%, 60%, or higher by weight while still exhibiting desirable sensory and flake integrity attributes. In various embodiments, the high protein flakes herein can include wheat gluten, wheat protein isolate, pea protein concentrate, and at least one of lactic acid, citric acid, and malic acid, amongst other ingredients.

While high protein, ready-to-eat flakes herein can be used by consumers as breakfast flakes, they can also be used in other ways. For example, high protein flakes herein can be added to other food products in order to increase the amounts of protein consumed. High protein flakes herein can also be used as a topping for other food products.

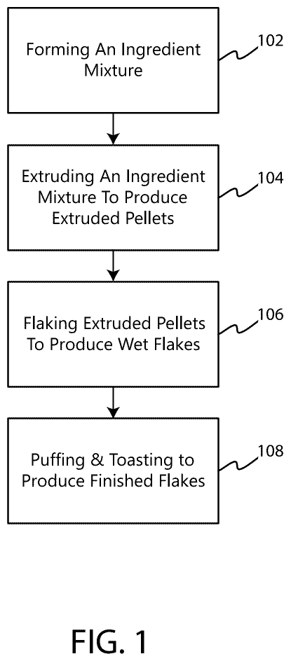

Referring now to FIG. 1, a flowchart is shown illustrating some operations in accordance with various methods of making high protein flakes herein. The method of making high protein flakes can include an operation of forming an ingredient mixture 102. Exemplary components of ingredient mixtures herein are described in greater detail below. However, in various embodiments, the ingredient mixture can include wheat gluten, wheat protein isolate, and pea protein concentrate, amongst other ingredients.

The method of making high protein flakes can also include an operation of extruding an ingredient mixture to produce extruded pellets 104. Various food extrusion systems can be used. The feed rate can vary depending on the system. However, in some embodiments the feed rate can be from 80 to 120 KG/HR, although other rates can also be used. In some embodiments, a water rate can be from 30 to 50 KG/HR, although other rates can also be used. Various die pressures can be used. It will be appreciated that the die pressure used can impact a degree of expansion of the material after it leaves the die. In various embodiments, the die pressure is set so that the degree of expansion is less than 10, 9, 8, 7, 6, 5, 4, 3, 2 or 1 percent by volume, or an amount falling within a range between any of the foregoing. In some embodiments, the die pressure can be from less than 1000 PSI and greater than 100 PSI. In some embodiments, the die pressure can be less than 900, 800, 700, 600, 500, 400 or 300 PSI.

Screw speeds of the extruder can vary depending on the specific extrusion equipment used. In various embodiments, the operation of extruding is performed with a screw speed of 200 to 400 RPM. In some embodiments, the operation of extruding is performed with a screw speed of 300 to 350 RPM. However, in some embodiments screw speeds can be used falling outside those ranges. The barrel temperature of the extruder can be controlled within a specific temperature range. In various embodiments, the operation of extruding is performed with a barrel temperature of 25 to 75 degrees Celsius. In various embodiments, the operation of extruding is performed with a barrel temperature of 35 to 40 degrees Celsius.

The method of making high protein flakes also includes a flaking extruded pellets to produce wet flakes 106 (or high-moisture flakes). In specific, a flaking mill can be used in order to flake extruded pellets. While not intending to be bound by theory, the temperature of the pellets as they enter the flaking operation is significant to the product obtained. Temperatures that are too high may result in a bulk density of the product that is undesirably low. Temperatures that are too low may result in a bulk density of the product that is undesirably high. In various embodiments, the extruded pellets are at a temperature of 80 to 200 degrees Fahrenheit before flaking. In various embodiments, the extruded pellets are at a temperature of 100 to 150 degrees Fahrenheit before flaking.

The roll pressure in the flaking mill can vary. In some embodiments, the roll pressure can be from 1100 to 1400 PSI, however other pressures can also be used herein. In some embodiments, the roll speed can be from 90-110/90-110 RPM, or about 100/100 RPM in some examples, though other roll speeds are contemplated herein. In some embodiments, a rotary feeder speed can be from about 0.6 to 1 RPM, though other rotary feeder speeds are also contemplated herein. It will be appreciated that parameters described herein can vary depending on the scale of production.

The method of making high protein flakes can also include an operation of puffing and toasting the wet flakes to produce finished flakes 108. Puffing and toasting can be performed with an oven. In some embodiments, puffing and toasting can be performed with a rotating drum oven. In some embodiments, puffing and toasting can be performed at an oven temperature of about 330 to 360 degrees Fahrenheit, though other temperatures are also contemplated herein. In some embodiments, the drum speed can be from about 240 to 280 Hz, though other drum speeds are also contemplated herein. In some embodiments, the blower speed can be from about 580 to 620 Hz, though other blower speeds are also contemplated herein.

Other operations may also be performed in accordance with embodiments herein beyond those shown in FIG. 1. For example, in some embodiments, an operation of applying a flavoring or other composition can also be included.

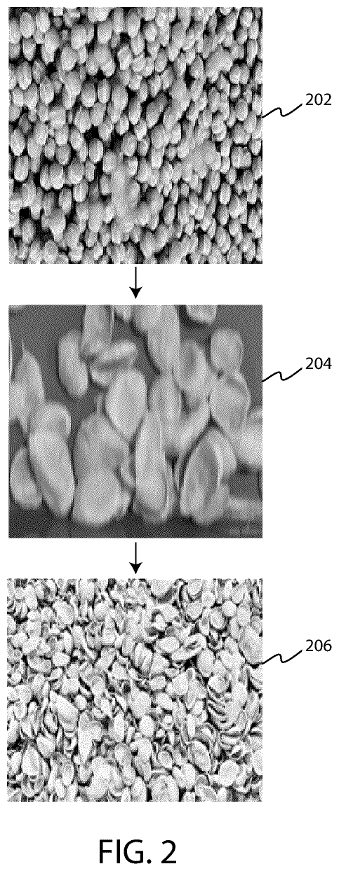

Referring now to FIG. 2, a schematic view of intermediate products and finished high protein flakes in accordance with various embodiments herein. In specific, FIG. 2 shows extruded pellets 202. In various embodiments, the extruded pellets can have a density of 475 to 700 g/L. In various embodiments, the extruded pellets 104 can have a density of 450 to 650 g/L.

The moisture content of the extruded pellets can be an important parameter to control to result in flakes with desirable levels of integrity. The moisture of the extruded pellets is significant as moisture levels that are too low may result in bulk densities of the finished flakes that are too high wherein moisture levels that are too high may result in bulk densities of the finished flakes that are too low. In various embodiments, the extruded pellets have a moisture content of 25 to 30 wt. percent or from 27 to 30 wt. percent.

FIG. 2 also shows exemplary wet flakes 204 as may be produced by a flaking operation herein. Thickness of the wet flakes 204 is an important parameter. Wet flakes that are too thin won't have sufficient integrity as finished flakes. Wet flakes that are too thick can result in difficulties in properly drying the wet flakes. In addition, flakes that are too thick, and in particular high protein flakes herein, can be too dense and hard and not pleasant to eat. High protein flakes are fundamentally different than grain or starch-base flakes in that grain or starch-based flakes can be much thicker without becoming too dense and hard. Drying is particularly challenging in the context of high protein flakes as too much heat exposure will result in undesirable browning of the flakes. In various embodiments, the wet flakes 204 can have a thickness of from 50 to 350 microns or from 90 to 250 microns. In various embodiments, the wet flakes 204 can have a moisture content of 26 to 31 wt. percent. In various embodiments, the wet flakes 204 can have a moisture content of 26 to 29 wt. percent.

FIG. 2 also shows exemplary finished flakes 206 as may be produced by a puffing and/or toasting operation herein. The finished flakes 206 can have a remarkably high protein content. In various embodiments, the finished flakes (described further below) have a protein content of at least 40, 45, 50, 55, 60, 65, 70 wt. % or higher. In some embodiments, the finished flakes can have a protein content falling within a range between any of the foregoing. In various embodiments, at least about 80, 85, 90, 95, 98, or 99 wt. % of total protein content of the flakes can be plant derived protein. In some embodiments, 100 wt. % of the total protein content of the flakes is plant derived protein.

As a non-refrigerated product, the amount of moisture is important to control. In various embodiments, the finished flakes 206 can have a moisture content of 1 to 5 wt. %. In various embodiments, the finished flakes can have a moisture content of 2 to 3 wt. %.

Bulk density provides a measure of the quality and integrity of the finished flakes. If bulk density is too high, it can mean that the finished flakes are too dense and hard. If bulk density is too low, it can mean that the finished flakes may easily break and lack desirable integrity.

In various embodiments, the finished flakes (dry flakes) herein can have a bulk density of 50, 60, 70, 80, 90, 100, 110, or 120 g/L, or an amount falling within a range between any of the foregoing, such as from 50 to 120 g/L.

The finished flakes can include substantial amounts of the ingredients herein contributing to protein content. For example, in various embodiments, the wheat gluten can be from 26 to 34 wt. % of the high protein flakes, the wheat protein isolate can be from 21 to 30 wt. % of the high protein flakes, and the pea protein concentrate can be from 19 to 27 wt. % of the high protein flakes. As another example, the wheat gluten can be from 28 to 32 wt. % of the high protein flakes, the wheat protein isolate can be from 23 to 28 wt. % of the high protein flakes, and the pea protein concentrate can be from 21 to 25 wt. % of the high protein flakes.

The high protein flakes herein can include a perimeter that is highly regular and smooth (e.g., lacking substantial jagged edges). A ratio of net area (or simply area) to convex area of a shape can be used to measure the regularity and smoothness of the perimeter. The convex area of an object is the area of a convex hull or bounding shape that encloses the object. By definition, the convex area is always at least as large as the net area of a shape. The higher the net area relative to the convex area, the less jagged the shape is. In various embodiments, the plurality of high protein flakes can have, on average, a net area that is at least 80%, 85%, 90%, 95%, 98% or 99% of the convex area of the plurality of high protein flakes, or a net area relative to convex area, on average, falling within a range between any of the foregoing. Pores can be an indication of the integrity of the high protein flakes. In various embodiments, the high protein flakes substantially lack pores greater than 1 mm in diameter.

### Ingredient Mixture

Various components contribute to the protein content of the flakes herein. By way of example, flakes herein can include at least wheat gluten, wheat protein isolate, and pea protein concentrate as protein rich ingredients.

The ratios of wheat gluten, wheat protein isolate, and pea protein concentrate can be significant. In various embodiments, the wheat protein isolate and the pea protein concentrate are in a ratio of 2:1 to 1:2 by weight.

The pH of the wheat protein isolate can impact various properties of the isolate impacting the process herein. In specific, it has been found that where the pH of wheat protein isolate is too high (e.g., not sufficiently acidic) then the resulting composition lacks sufficient cohesiveness and the flakes produced do not have sufficient structural integrity. In various embodiments, the wheat protein isolate has a pH of less than 6.0, 5.8, 5.6, 5.4, 5.2, 5.0, 4.8, 4.6, 4.4, 4.2, 4.0 or less, or a pH falling within a range between any of the foregoing. It will be appreciated that the pH of dry components or those not starting as an aqueous solution herein can be measured by first preparing a 10% dilution (or 10 fold dilution) in water and then measuring the pH of the resulting solution.

In some embodiments, the pH of the combination of wheat gluten, wheat protein isolate, and pea protein concentrate (versus just the wheat protein isolate in isolation) can be adjusted to aid in the process herein. In various embodiments, the pH of the combination of wheat gluten, wheat protein isolate, and pea protein concentrate can be less than 6.0, 5.8, 5.6, 5.4, 5.2, 5.0, 4.8, 4.6, 4.4, 4.2, 4.0 or less, or a pH falling within a range between any of the foregoing. In some embodiments, the pH of all components of the flakes can be less than 6.0, 5.8, 5.6, 5.4, 5.2, 5.0, 4.8, 4.6, 4.4, 4.2, 4.0 or less, or a pH falling within a range between any of the foregoing.

Each of the protein rich ingredients serves an important purpose and they work together synergistically to produce flakes with desirable levels of integrity. It has been found that the wheat protein isolate by itself (as a protein rich ingredient) cannot be processed into flakes. Rather, the wheat protein isolate by itself is very sticky. Further, it has been found that the pea protein isolate by itself (as a protein rich ingredient) cannot be processed into flakes with sufficient integrity. Rather, the pea protein isolate results in very weak flakes without sufficient integrity that easily crumble. Further, it has been found that wheat gluten by itself (as a protein rich ingredient) cannot be processed into flakes with sufficient integrity. Rather, the wheat gluten results in very weak flakes without sufficient integrity and a palatable texture. However, when these components are combined in the amounts described herein, flakes can be produced with a palatable texture exhibiting substantial integrity.

The total amounts of the protein rich ingredients can be substantial. In various embodiments, the ingredient mixture can include from 33 to 44 weight percent of the wheat gluten, from 17 to 37 weight percent of the wheat protein isolate, and from 15 to 35 weight percent of the pea protein concentrate, wherein the preceding weight percentages are with respect to a total weight of the wheat gluten, the wheat protein isolate, and the pea protein concentrate. In various embodiments, the ingredient mixture can include from 36 to 41 weight percent of the wheat gluten, from 30 to 34 weight percent of the wheat protein isolate, and from 27 to 32 weight percent of the pea protein concentrate, wherein the preceding weight percentages are with respect to a total weight of the wheat gluten, the wheat protein isolate, and the pea protein concentrate.

Remarkably, it has been found that acidifying the formulation using, for example a carboxylic acid like lactic acid, citric acid, or malic acid, can desirably reduce flake density, preventing the flakes from being too dense and hard while also preserving desirable integrity and not allowing the flakes to easily break. Optimal amounts of a carboxylic acid such as lactic acid can allow flake density to be reduced by at least 30, 35, or even 40 percent compared with an otherwise identical formulation.

In some embodiments, a carboxylic acid such as at least one of lactic acid, citric acid, or malic acid can be added. However, an insufficient amount of acid being added does not result in desirable reductions in flake density. In some embodiments, at least about 0.3, 0.4, 0.5, or 0.6 wt. % of lactic acid as a 50% solution in water (about 6.6 molar) can be added (or an equivalent amount of lactic acid in a different molar strength solution). Too much added acid can, however, result in an undesirable sour taste. In some embodiments, less than about 0.7, 0.65, or 0.6 wt. % of lactic acid as a 50% solution in water (about 6.6 molar) can be added. In some embodiments, an amount of lactic acid can be added falling within a range between any of the foregoing. In some embodiments, lactic acid (or citric acid or malic acid) are included at an amount of 0.6 wt. % to 1.2 wt. % of the total weight of the wheat gluten, the wheat protein isolate, and the pea protein concentrate. In some embodiments, lactic acid (or citric acid or malic acid) is included at an amount sufficient to lower the pH of the wet flakes to a pH of 6 or less. In some embodiments, the wet flakes have a pH of 4 to 6.

In some embodiments, the ingredient mixture can also include dairy based protein. For example, in some embodiments, the ingredient mixture can include 1, 3, 5, 7, 10, 15, 20, 25 or more weight percent (with respect to the total weight of the flaked product) of one or more dairy protein components. Exemplary dairy protein components can include, but are not limited to, whey products, milk products, and other dairy-derived components. Examples of whey products include whey protein concentrates (WPC), whey protein isolates (WPI), and milk-derived whey. Examples of milk products include milk protein concentrates (MPC), milk protein isolates (MPI), and micellar casein.

However, in other embodiments, the ingredient mixture herein (and the resulting finished flakes) is 100% plant derived materials.

In various embodiments, a starch component can also be a part of the ingredient mixture. For example, in various embodiments a pregelatinized or precooked starch can be added to the ingredient mixture. In various embodiments, the pregelatinized or precooked starch can include at least one of a pregelatinized corn starch, a pregelatinized rice starch, a pregelatinized potato flour, a pregelatinized tapioca flour, and a precooked pulse flour.

It will be appreciated that the ingredient mixture herein can include many other specific ingredients. For example, in various embodiments, the ingredient mixture can further include glycerol monostearate. The glycerol monostearate can serve as a processing aid herein, amongst other functions. In some embodiments, other processing aids can also be used. Other components can also be added to the ingredient mixture herein including, but not limited to, sweeteners (such as sugar, stevia leaf extract, and the like), flavorings (both natural and artificial), colorings (both natural and artificial), chocolate, cinnamon, vanilla, and the like. In addition, various other components can be added to a high protein flaked food product herein including, but not limited to, nuts, fruits, and the like.

### EXAMPLES

### Example 1: High Protein Flakes and High Protein Flaked Food Product

Flour formulations are prepared consistent with embodiments herein. The flour formulations are as shown below in Table 2 (wt. % numbers).

TABLE 1

| Ingredients | Abbreviation |
|---|---|
| Wheat Gluten | WG |
| Wheat Protein Isolate | WPI |
| Pea Protein Concentrate | PPC |
| Corn Pregel | CP |
| Salt (NaCl) | Salt |
| Glycerol Monostearate | GM |

TABLE 2

| Formulation | WG | WPI | PPC | CP | Salt | GM |
|---|---|---|---|---|---|---|
| 1 | 25 | 20 | 26 | 26 | 1.5 | 1.5 |
| 2 | 25 | 25 | 24 | 24 | 1 | 1 |
| 3 | 25 | 31 | 20 | 21 | 2 | 1 |
| 4 | 28 | 20 | 25 | 25 | 1 | 1 |
| 5 | 28 | 25 | 23 | 22 | 1 | 1 |
| 6 | 28 | 30 | 19 | 21 | 1.1 | 0.9 |
| 7 | 30 | 20 | 25 | 22 | 1.2 | 1.8 |
| 8 | 30 | 25 | 23 | 20 | 1.2 | 0.8 |
| 9 | 30 | 30 | 20 | 18 | 1 | 1 |
| 10 | 32 | 26 | 22 | 18 | 1 | 1 |
| 11 | 35 | 25 | 20 | 18 | 1.2 | 0.8 |

The flour formulation is then combined with components such as sweetener, water, and flavorings to prepare an ingredient mixture used to make flakes in a manner consistent with the operations shown in FIG. 1.

The flakes themselves can function as a high protein flaked food product herein or can then combined with other components (fruits, nuts, etc.) to form a high protein flaked food product with the flakes representing from 75 to 85 percent by weight of the high protein flaked food product.

### Example 2: Effects of Varying Protein Component Amounts on Flake Texture

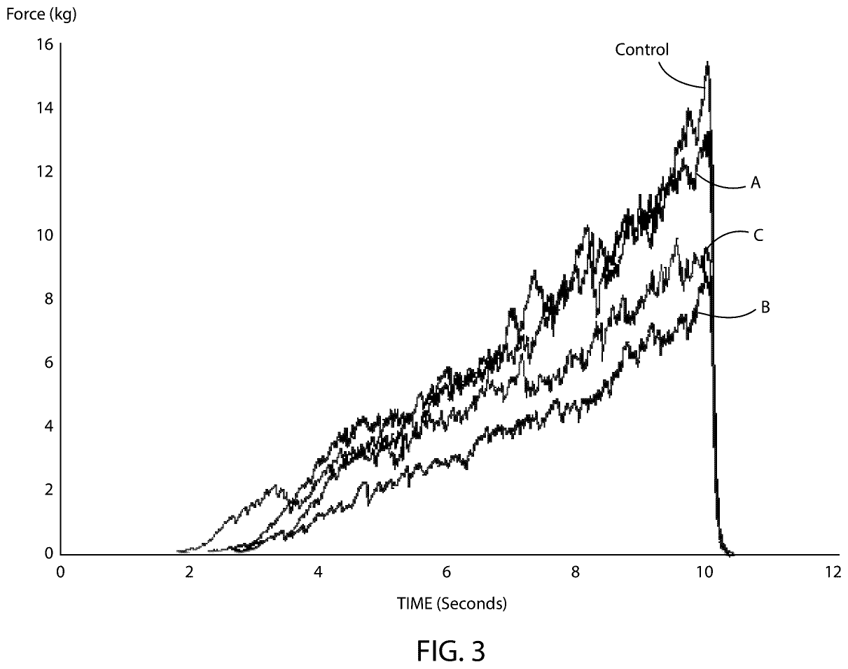

A Texture Analyzer XT.XTplus™ from Texture Technologies Corp. was used to evaluate finished flakes consistent with the formulations described in Table 2 above (Control) along with three variant formulations including: A.) with twice the amount of wheat protein isolate-roughly 50 wt. %, B.) with twice the amount of pea protein concentrate (roughly 46 wt. %), and C.) with twice the amount of pea protein concentrate (roughly 46 wt. %) along with an increased amount of water. The results are shown in FIG. 3. The results show that the control formulation exhibited the best crispy flake texture.

### Example 3: Effects of Pellet Moisture on Flake Texture

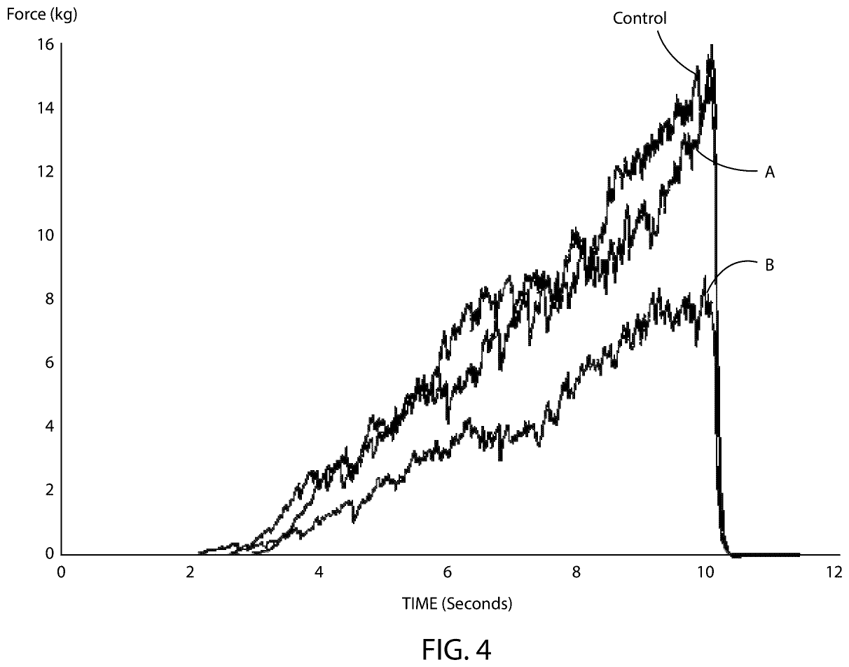

A Texture Analyzer XT.XTplus™M from Texture Technologies Corp. was used to evaluate finished flakes consistent with the formulations described in Table 2 above as made using operations described herein with using three different pellet moisture levels: 30% (Control), 34% (A), and 38% (B). The results are shown in FIG. 4. The results show that the pellets with 30% moisture resulted in the best crispy flake texture.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method of making high protein flakes comprising:
forming an ingredient mixture, the ingredient mixture comprising
wheat gluten;
wheat protein isolate;
pea protein concentrate, wherein the wheat protein isolate and the pea protein concentrate are in a ratio of 2:1 to 1:2 by weight; and
at least one of lactic acid, citric acid, and malic acid;
extruding the ingredient mixture to produce extruded pellets;
flaking the extruded pellets to produce wet flakes; and
puffing and toasting the wet flakes to produce finished flakes, wherein the finished flakes have a protein content of at least 50 wt. %.

2. The method of claim 1, the ingredient mixture further comprising lactic acid.

3. The method of claim 2, wherein the lactic acid is included at an amount of 0.6 wt. % to 1.2 wt. % of the total of the wheat gluten, the wheat protein isolate, and the pea protein concentrate.

4. The method of claim 2, wherein the lactic acid is included at an amount sufficient to lower the pH of the wet flakes to a pH of 6 or less.

5. The method of claim 1, wherein the wet flakes have a pH of 4 to 6.

6. The method of claim 1, further comprising adding a pregelatinized or precooked starch to the ingredient mixture.

7. (canceled)

8. The method of claim 1, wherein the finished flakes have a protein content of at least 60 wt. %.

9-11. (canceled)

12. The method of claim 1, the ingredient mixture further comprising:
from 33 to 44 weight percent of the wheat gluten;
from 17 to 37 weight percent of the wheat protein isolate; and
from 15 to 35 weight percent of the pea protein concentrate; and
wherein the preceding weight percentages are with respect to a total weight of the wheat gluten, the wheat protein isolate, and the pea protein concentrate.

13. The method of claim 1, the ingredient mixture further comprising:
from 36 to 41 weight percent of the wheat gluten;
from 30 to 34 weight percent of the wheat protein isolate; and
from 27 to 32 weight percent of the pea protein concentrate; and
wherein the preceding weight percentages are with respect to a total weight of the wheat gluten, the wheat protein isolate, and the pea protein concentrate.

14-17. (canceled)

18. The method of claim 1, the wet flakes having a thickness of 90 to 250 microns.

19. The method of claim 1, the wet flakes having a moisture content of 26 to 31 wt. percent.

20-27. (canceled)

28. The method of claim 1, wherein at least 100 percent by weight of the total protein content of the finished flakes is plant protein.

29. A high-protein flaked food product comprising:
a plurality of high-protein flakes, the high-protein flakes comprising wheat gluten;
wheat protein isolate;
pea protein concentrate; and
at least one of lactic acid, citric acid, and malic acid;
wherein the high-protein flakes have an average protein content of at least 50% by weight; and
wherein the wheat protein isolate and the pea protein concentrate are in a ratio of 2:1 to 1:2 by weight.

30. The high-protein flaked food product of claim 29, the high-protein flakes comprising lactic acid.

31. The high-protein flaked food product of claim 29, wherein the flakes have a pH of 4 to 6.

32. The high-protein flaked food product of claim 29, wherein the high-protein flakes have an average protein content of at least 60% by weight.

33. The high-protein flaked food product of claim 29, wherein the plurality of high-protein flakes have, on average, a net area that is at least 85% of an average convex area of the plurality of high-protein flakes.

34-35. (canceled)

36. The high-protein flaked food product of claim 29,
wherein the wheat gluten is from 26 to 34 wt. % of the high-protein flakes;
wherein the wheat protein isolate is from 21 to 30 wt. % of the high-protein flakes; and
wherein the pea protein concentrate is from 19 to 27 wt. % of the high-protein flakes.

37-38. (canceled)

39. The high-protein flaked food product of claim 29, the plurality of high-protein flakes having a bulk density of 50 to 120 g/L.

40-41. (canceled)

42. The high-protein flaked food product of claim 29, wherein the protein content is 100 percent by weight plant protein.
